(19) United States
(12) Patent Application Publication
(10) Pub. No.: US 2007/0024346 A1
(43) Pub. Date: Feb. 1, 2007

(54) Charge pump circuit and semiconductor integrated circuit incorporating the same

(75) Inventors: Takahisa Takahashi, Kyoto (JP); Toshinobu Nagasawa, Osaka (JP); Tetsushi Toyooka, Kyoto (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi (JP)

(21) Appl. No.: 11/488,480

(22) Filed: Jul. 18, 2006

(30) Foreign Application Priority Data
Jul. 28, 2005 (JP) JP2005-218285

(51) Int. Cl. G05F 1/10

(52) U.S. Cl. 327/536

(57) ABSTRACT

A charge pump circuit includes terminals that are connectable with a flying capacitor and a charge capacitor, respectively, and driving transistors connected with the terminals, a power supply voltage, and a ground potential, for controlling the charging of the flying capacitor and the transfer of charges from the flying capacitor to the charge capacitor. By repeating alternately an operation of charging the flying capacitor and an operation of transferring charges stored in the flying capacitor to the charge capacitor according to control signals supplied to gates of the transistors, the power source voltage is stepped down or stepped up. At least one of the driving transistors has its gate to be connected to a driving buffer via an impedance element so that the control signal is supplied thereto via the driving buffer. A switching element is connected between the impedance element and the gate of the driving transistor so that when the driving transistor is turned off, the gate is switched to low impedance by the switching element.

### BACKGROUND OF THE INVENTION

1. Field of the Invention

The present invention relates to a power supply circuit, particularly to a voltage supply circuit for supplying a voltage different from a power supply voltage by using a voltage step-up or step-down charge pump circuit.

2. Description of Related Art

A configuration of a conventional voltage step-down charge pump circuit is described with reference to a circuit diagram shown in FIG. 8. The charge pump circuit 100 has terminals 2a and 2b to which a flying capacitor 2 is connected, and a terminal 3a to which a charge capacitor 3 is connected. A voltage step-down operation by the charge pump circuit 100 is carried out by repeating an operation of charging the flying capacitor 2 with a power supply voltage and transferring charges from the flying capacitor 2 to the charge capacitor 3.

To carry out the foregoing operation, the charge pump circuit 100 includes a driving transistor 4 (PMOS), a driving transistor 5 (NMOS), a driving transistor 6 (NMOS), and a driving transistor 7 (NMOS). The driving transistor 4 is connected between a positive terminal of the flying capacitor 2 and a power supply voltage VDD. The driving transistor 5 is connected between the positive terminal of the flying capacitor 2 and a ground voltage GND. The driving transistor 6 is connected between a negative terminal of the flying capacitor 2 and the ground voltage GND. The driving transistor 7 is connected between the negative terminal of the flying capacitor 2 and a negative terminal of the charge capacitor 3. A positive terminal of the charge capacitor 3 is connected to the ground voltage GND.

A gate driving buffer 8 is connected to a gate of the driving transistor 4. The gate driving buffer 8 is composed of a series circuit of a PMOS transistor 8a and a NMOS transistor 8b, and connection nodes of both the transistors 8a and 8b are connected to the gate of the driving transistor 4.

The driving transistors 4 to 7 are controlled by gate control signals va1 and va2 as shown in FIG. 9, which are outputted from a clock generator 9. The gate control signal va1 is supplied to gates of the PMOS transistor 8a and the NMOS transistor 8b that compose the gate driving buffer 8. The gate driving buffer 8 outputs a gate control signal va10 according to the gate control signal va1, and supplies the same to the gate of the driving transistor 4. The gate control signal va1 is supplied also to a gate of the driving transistor 6. The gate control signal va2 is supplied to gates of the driving transistors 5 and 7 from the clock generator 9.

The operation of the charge pump circuit 100 is described with reference to FIG. 9. FIG. 9 shows the gate control signals va1 and va2 from the clock generator 9, the gate control signal va10 from the gate driving buffer 8, and a current i10 flowing to the flying capacitor 2 via the driving transistor 4.

First, in a charging mode shown in FIG. 9, the gate control signals va1 and va2 from the clock generator 9 are at a “H” level and a “L” level, respectively. On supply of the gate control signal va1 (“H” level) from the clock generator 9 to the gate driving buffer 8, a gate control signal va10 (“L” level) is applied to the driving transistor 4 by the gate driving buffer 8. At the same time, the gate control signal va1 (“H” level) is applied to the driving transistor 6 and the gate control signal va2 (“L” level) is applied to the driving transistors 5 and 7, thereby turning on the driving transistors 4 and 6, while turning off the driving transistors 5 and 7.

Since a source and a drain of the driving transistor 4 are connected to the power supply voltage VDD and the positive terminal of the flying capacitor 2, respectively, while a drain of the driving transistor 6 is connected to the negative terminal of the flying capacitor 2 and a source of the driving transistor 6 is connected to the ground voltage GND, the flying capacitor 2 is charged by a VDD-GND voltage.

Next, in the charging mode shown in FIG. 9, the gate control signals va1 and va2 from the clock generator 9 are shifted to the “L” level and the “H” level, respectively. Accordingly, the gate control signal va10 (“H” level) is applied to the driving transistor 4, the gate control signal va1 (“L” level) is applied to the driving transistor 6, and the gate control signal va2 (“H” level) is applied to the driving transistors 5 and 7. This turns on the driving transistors 5 and 7, while turning off the driving transistors 4 and 6.

A drain of the driving transistor 5 is connected to the positive terminal of the flying capacitor 2, and a source of the driving transistor 5 is connected to the ground voltage GND. Further, a drain of the driving transistor 7 is connected to the negative terminal of the flying capacitor 2, and a source of the driving transistor 7 is connected to the negative terminal of the charge capacitor 3. Therefore, in the charging mode, charges stored in the flying capacitor 2 in the charging mode are transferred to the charge capacitor 3.

By repeating the above-described charging-and-discharging-mode operation, a negative power supply VSS is generated between the source of the driving transistor 7 and the negative terminal of the charge capacitor 3. If capacitors having capacitances equal to each other are used as the flying capacitor 2 and the charge capacitor 3, the negative power supply VSS is shifted to a level of −(½)VDD as a result of the first round of the charging and discharging operation, to a level of −(¾)VDD as a result of the second round thereof, and to a level of −(⅞)VDD as a result of the third round thereof. Thus, by repeating the charging and discharging operation, the negative power supply VSS is made to be a level of −VDD ideally, if the charge pump circuit 100 is under no-load conditions.

As shown in FIG. 9, a dead time is provided between the transition of the gate control signals va10 and va1 and the transition of the gate control signal va2. During the dead time, all of the driving transistors 4, 5, 6, and 7 are turned off, so as to prevent the charge pump circuit 100 from being shifted to a through-current state.

However, the above-described conventional charge pump circuit has a drawback as described below. In the charge pump circuit 100 in FIG. 8, in the charging mode, the gate control signal va10 is shifted to the “L” level, the gate control signal va1 is shifted to the “H” level, and the gate control signal va2 is shifted to the “L” level. This causes the flying capacitor 2 to be charged by a VDD-GND voltage. Here, since the gate control signal va10 has an abruptly falling edge and the gate control signal va1 has an abruptly rising edge as shown in FIG. 9, the flying capacitor 2 is charged in a short time. As a result, a current i10 in a spike form having an abruptly rising edge flows into the flying capacitor 2, thereby causing the power supply voltage to fluctuate.

Particularly, in the case where a signal processing circuit and a charge pump circuit are mounted on one substrate in order to expand an output dynamic range of an analog circuit such as a signal processing circuit, the flow of the current i10 in the spike form in the charge pump circuit 100 has a significant impact. In other words, when the above-described current in the spike form is generated from the circuit pump circuit 100, it is superimposed as a noise in a spike form (hereinafter referred to as “spike noise”) on an output signal of the signal processing circuit. Such a problem occurs not only in the voltage step-down charge pump circuit 100 as shown in FIG. 8 but also in a voltage step-up charge pump circuit in the same manner.

A charge pump circuit configured so that such a spike noise is reduced is disclosed in JP 2003-153524 A. In a voltage step-up charge pump circuit, a capacitor is driven by a current supply so that a spike noise in a voltage step-up operation is reduced.

However, the circuit disclosed in JP 2003-153524 A has a complex structure, thereby hindering the downsizing of the circuit.

### SUMMARY OF THE INVENTION

The present invention is to solve the above-described problems, and an object of the present invention is to provide a charge pump circuit in which the occurrence of a current in a spike form during operation is suppressed with a simple configuration.

Another object of the present invention is to provide a semiconductor integrated circuit including a charge pump circuit capable of reducing influences on an analog circuit such as a signal processing circuit provided on the same substrate.

The charge pump circuit of the present invention includes: terminals connectable with a flying capacitor to be charged by a power supply voltage; a terminal connectable with a charge capacitor to be charged with charges stored in the flying capacitor and transferred thereto; and driving transistors connected with the terminals connectable with the flying capacitor and the charge capacitor, the power supply voltage, and a ground potential, for controlling the charging of the flying capacitor, and the transfer of charges from the flying capacitor to the charge capacitor. The charge pump circuit is driven to repeat alternately an operation of charging the flying capacitor and an operation of transferring charges stored in the flying capacitor to the charge capacitor according to control signals supplied to gates of the driving transistors, so that the charge capacitor outputs a stepped-down or stepped-up power supply voltage. A driving buffer is connected to a gate of at least one of the driving transistors via an impedance element so that the control signal is supplied thereto via the driving buffer. A switching element is connected between the impedance element and the gate of the driving transistor so that when the driving transistor is turned off, the gate is switched forcedly to low impedance by the switching element.

A semiconductor integrated circuit of the present invention is configured to include: a charge pump circuit of the foregoing configuration; and a signal processing circuit that is provided on the same substrate on which the charge pump circuit is provided, that is connected with the charge pump circuit, and that can be driven with the same power supply voltage as that for driving the charge pump circuit.

### BRIEF DESCRIPTION OF THE DRAWINGS

FIG. 1 is a circuit diagram showing a configuration of a charge pump circuit according to Embodiment 1 of the present invention.

FIG. 2 is a waveform diagram showing gate control signals in the charge pump circuit shown in FIG. 1.

FIG. 3 is a circuit diagram showing another configuration example of the charge pump circuit according to Embodiment 1.

FIG. 4 is a waveform diagram showing gate control signals in the charge pump circuit shown in FIG. 3.

FIG. 5 is a circuit diagram showing still another configuration example of the charge pump circuit according to Embodiment 1.

FIG. 6 is a waveform diagram showing gate control signals in the charge pump circuit shown in FIG. 5.

FIG. 7 is a circuit diagram showing a configuration of a semiconductor integrated circuit according to Embodiment 2 of the present invention.

FIG. 8 is a circuit diagram showing a configuration of a conventional charge pump circuit.

FIG. 9 is a waveform diagram showing gate control signals in the charge pump circuit shown in FIG. 8.

### DETAILED DESCRIPTION OF THE INVENTION

The charge pump circuit of the present invention is configured so that an impedance element is provided additionally on an output side of the driving buffer, whereby rising and falling edges of a gate control signal applied to the transistor connected to the buffer can be made gradual. Further, a switching element is connected to the gate of the transistor so that when the transistor is turned off, the gate of the transistor is switched to low impedance forcedly by the switching element, whereby fluctuation of the gate control signal is suppressed. Such a simple configuration makes it possible to suppress the current in the spike form effectively.

In the charge pump circuit of the present invention, the switching element may be composed of a switch that provides electric connection between the gate of the driving transistor connected with the driving buffer and the power supply voltage when the driving transistor is turned off.

Further, the driving transistors may be configured to include: driving transistors connected between a positive terminal of the flying capacitor and the power supply voltage and between a negative terminal of the flying capacitor and the ground potential, respectively, for controlling the charging of the flying capacitor; and driving transistors connected between the positive terminal of the flying capacitor and the ground potential and between the negative terminal of the flying capacitor and the charge capacitor, respectively, for controlling the transfer of charges from the flying capacitor to the charge capacitor.

Alternatively, the driving transistors may be configured to include: driving transistors connected between a positive terminal of the flying capacitor and the power supply voltage and between a negative terminal of the flying capacitor and the ground potential, respectively, for controlling the charging of the flying capacitor; and driving transistors connected between the positive terminal of the flying capacitor and the charge capacitor and between the negative terminal of the flying capacitor and the power supply voltage, respectively, for controlling the transfer of charges from the flying capacitor to the charge capacitor.

With the semiconductor integrated circuit of the present invention configured so that the charge pump circuit is provided on the same substrate that a signal processing circuit is provided on, influences of the charge pump circuit on an analog circuit of the signal processing circuit on the same substrate can be reduced.

In the semiconductor integrated circuit of the present invention, the switching element can be composed of a switch that provides electric connection between the gate of the driving transistor connected with the driving buffer and the power supply voltage when the driving transistor is turned off.

Hereinafter, the present invention will be described in detail by way of illustrative embodiments with reference to the drawings.

### Embodiment 1

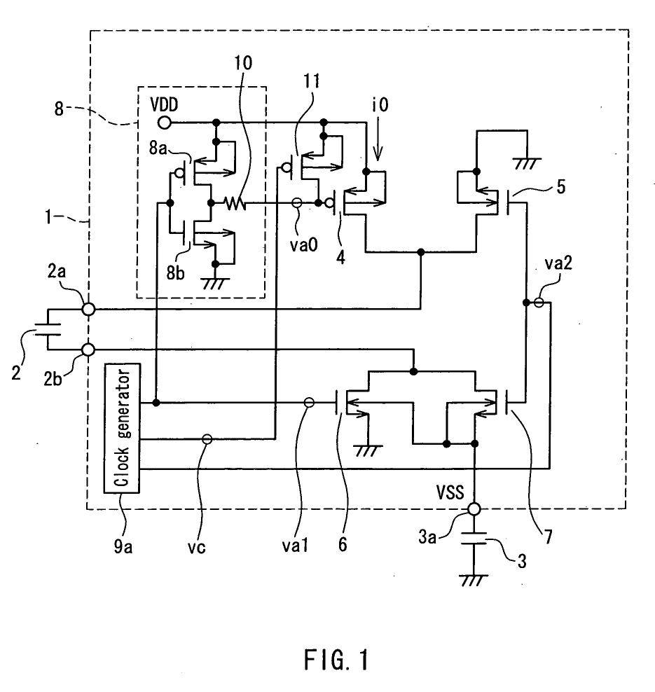

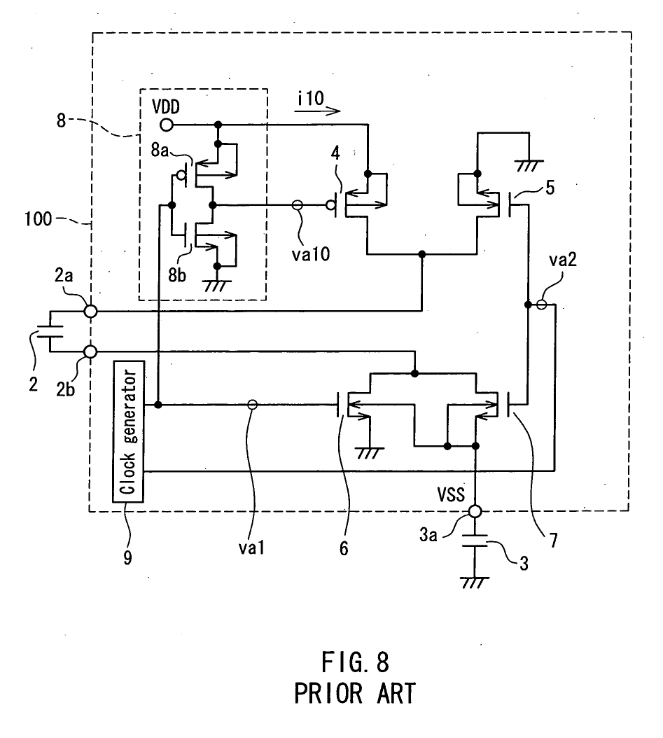

A configuration of a charge pump circuit 1 according to Embodiment 1 of the present invention is described with reference to a circuit diagram shown in FIG. 1. It should be noted that the same or similar elements as those of the circuit shown in FIG. 8 are designated by the same or similar reference numerals for describing the same.

The charge pump circuit 1 of FIG. 1 is configured by modifying the configuration of the conventional charge pump circuit 100 of FIG. 8 by adding a gate resistor 10 in the gate driving buffer 8 and a gate voltage keeping switch 11.

The charge pump circuit 1 includes driving transistors 4 to 7 like those of the circuit of FIG. 8. The gate resistor 10 is connected between the gate of the driving transistor 4 and an output node of the gate driving buffer 8. The gate resistor 10 is an output impedance of the gate driving buffer 8. The gate voltage keeping switch 11 is connected between the gate of the driving transistor 4 and the power supply VDD, and is composed of a PMOS transistor, for example.

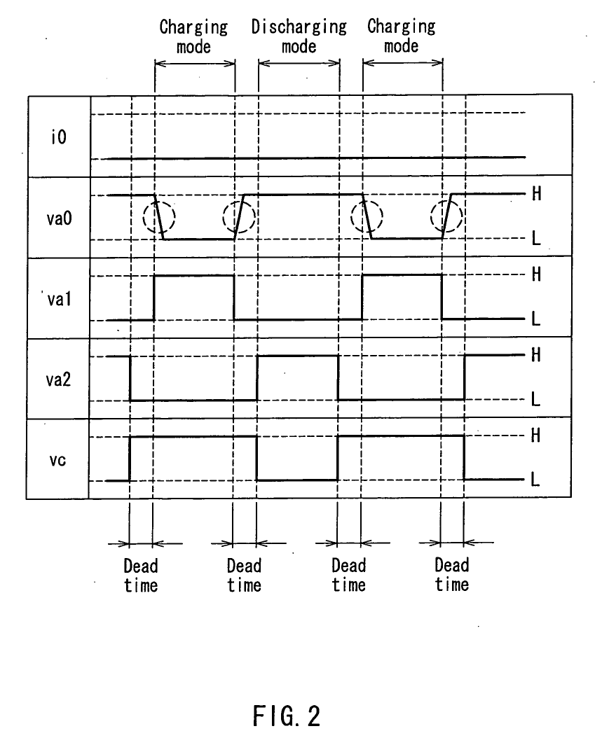

The driving transistors 4 to 7 are controlled according to gate control signals va1 and va2 as shown in FIG. 2, which are outputted by a clock generator 9a composing a control circuit. The gate control signal va1 is supplied to gates of a PMOS transistor 8a and a NMOS transistor 8b that compose the gate driving buffer 8, and a gate of the driving transistor 6. The gate control signal va2 is supplied to gates of the driving transistors 5 and 7. The clock generator 9a further outputs a gate control signal vc as shown in FIG. 2, which is supplied to a gate of the gate voltage keeping switch 11.

A signal outputted by the gate driving buffer 8 according to the gate control signal va1 fed to the gates of the PMOS transistor 8a and the NMOS transistor 8b is supplied, as a gate control signal va0, to a gate of the driving transistor 4 via the gate resistor 10.

The gate voltage keeping switch 11 is a switch for short-circuiting the gate of the driving transistor 4 to the power supply VDD, and has a function of keeping a gate voltage of the driving transistor 4. The opening and closing of the switch 11 is controlled according to the gate control signal vc. The transitions of the gate control signal vc are set to occur at the same timings as the gate control signal va2.

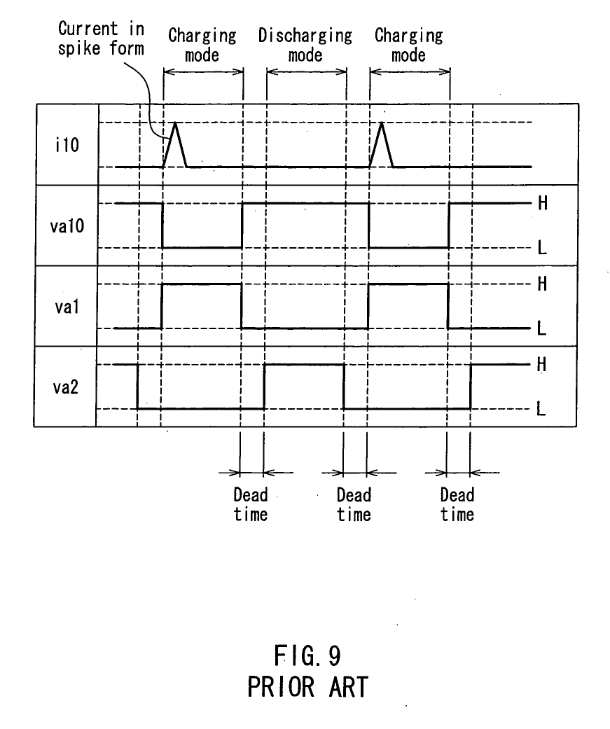

This operation of the charge pump circuit 1 is shown in a waveform diagram of FIG. 2. FIG. 2 shows the gate control signals va1, va2, and vc from the clock generator 9a, the gate control signal va0 from the gate driving buffer 8, and a current i0 flowing into the flying capacitor 2 via the driving transistor 4. A basic charging and discharging operation is identical to that of the conventional example described with reference to FIG. 9. In the present embodiment, the operation by the gate resistor 10 and the gate voltage keeping switch 11 is different from the conventional case, as described below.

First, a case in which only the gate resistor 10 is added is considered. The gate control signal va0 is a waveform signal supplied from the gate driving buffer 8 via the gate resistor 10 in response to input of the gate control signal va1. This makes the rising and falling of the gate control signal va0 gradual as shown in FIG. 2, according to a time constant determined by a gate-drain parasitic capacitance and a gate-source parasitic capacitance of the driving transistor 4 and the gate resistor 10. Therefore, the occurrence of fluctuation of the power supply voltage due to the flowing of the current i0 in a spike form into the flying capacitor is suppressed.

However, the following inconvenience occurs due to the addition of the gate resistor 10. At the instant at which the charge pump circuit is switched from the charging mode to the discharging mode, the gate control signal va2 is shifted from the “L” level to the “H” level. This turns on the driving transistors 5 and 7. Here, a current is generated between the power supply VDD and the ground GND via the gate driving buffer 8, the gate resistor 10, the gate-drain parasitic capacitance of the driving transistor 4, and the driving transistor 5. The current thus generated lowers the gate control voltage va0, thereby turning on the driving transistor 4. As a result, the charge pump circuit becomes in a through-current state, whereby a current in a spike form flows from the power supply VDD to the ground GND and the negative power supply VSS.

To cope with this, in the present embodiment, the gate voltage keeping switch 11 is provided further. In the discharging mode, the gate control signal vc is at the “L” level, thereby turning on the gate voltage keeping switch 11. This causes the gate control voltage va0 to be kept at the VDD level, which results in that the driving transistor 4 is never turned on in the discharging mode. Since the switch 11 has to be turned on in the discharging mode, the transitions of the gate control signal vc for controlling the switch 11 have to occur at the same timings as those of the gate control signal va2 for controlling the driving transistors 5 and 7.

As described above, according to Embodiment 1 of the present invention, by adding the gate resistor 10 and the gate voltage keeping switch 11, the gate control signal va0 for the driving transistor 4 can be made to have gradually rising and falling edges. Further, the gate voltage keeping switch 11 prevents voltage decrease of the gate control signal va0 that occurs due to the addition of the gate resistor 10. As a result, the current in the spike form, which occurs during charging in a conventional circuit, can be suppressed.

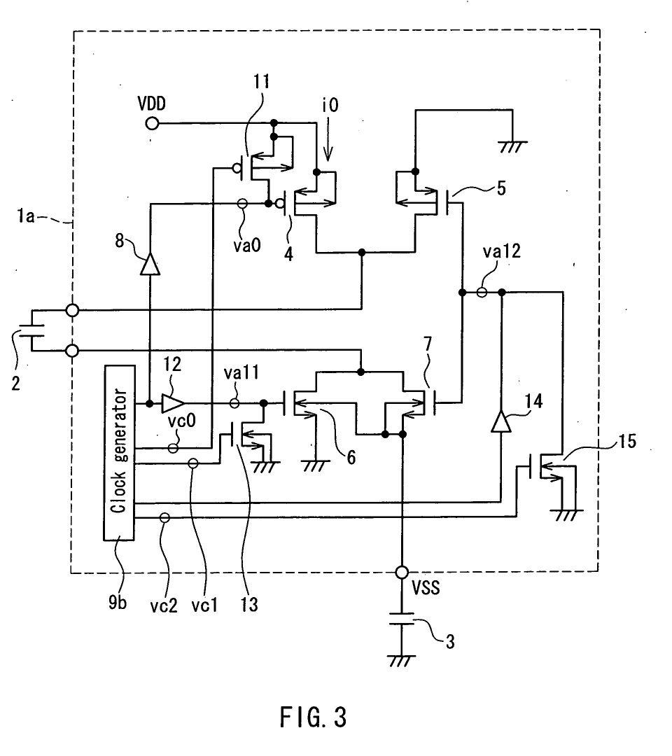

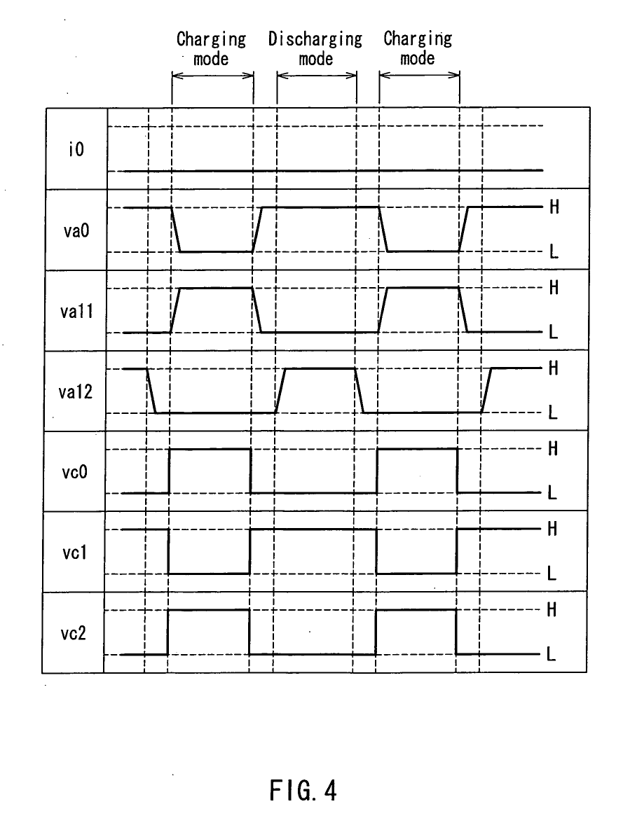

Though the above-described embodiment has a configuration in which the gate resistor 10 and the gate voltage keeping switch 11 are connected additionally to the gate of the driving transistor 4, the present invention is not limited to this configuration. More specifically, each of the driving transistors 5, 6, and 7 may be configured so that the same gate driving buffer as the gate driving buffer 8 having a gate resistor and the same switch as the gate voltage keeping switch 11 are connected additionally at a gate of the driving transistor. Such a configuration makes it possible to suppress the current in the spike form occurring at the respective driving timings. A circuit diagram of a charge pump circuit having such a configuration is shown in FIG. 3, and timing clocks of the same are shown in FIG. 4.

In the charge pump circuit 1a of FIG. 3, a gate driving buffer 12 is connected to a gate of a transistor 6 while a gate driving buffer 14 is connected to gates of driving transistors 5 and 7. A gate control signal (not shown) from a clock generator 9b is supplied as gate control signals va11 and va12 via the gate driving buffers 12 and 14, respectively. The gates of the driving transistors 5, 6, and 7 are connected to a ground voltage GND via gate voltage keeping switches 13 and 15, each of which is formed with a NMOS transistor. The gate voltage keeping switches 11, 13, and 15 are controlled according to gate control signals vc0, vc1, and vc2, respectively.

Operations of the gate driving buffers 12 and 14 and the gate voltage keeping switches 13 and 15, which are indicated by timing clocks shown in FIG. 4, are similar to those of the gate driving buffer 8 and the gate voltage keeping switch 11.

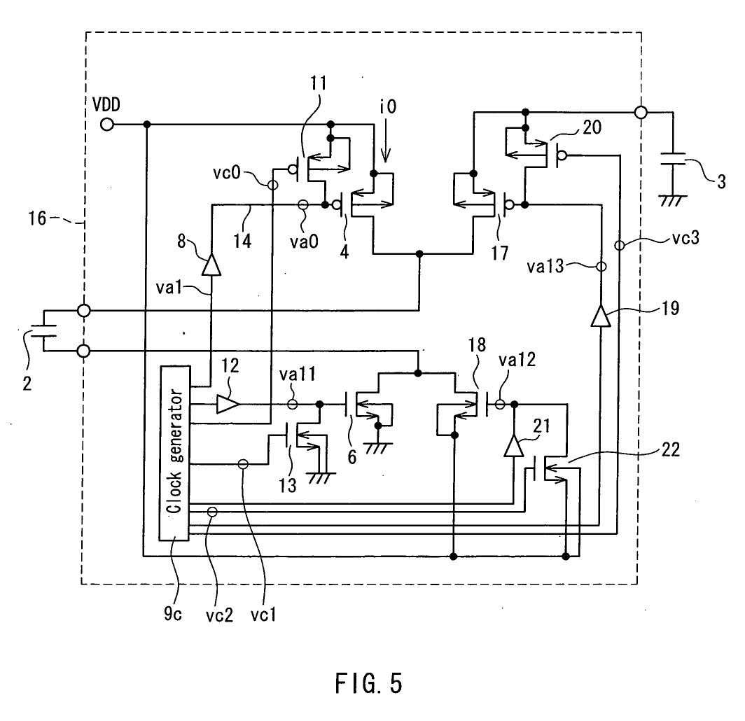

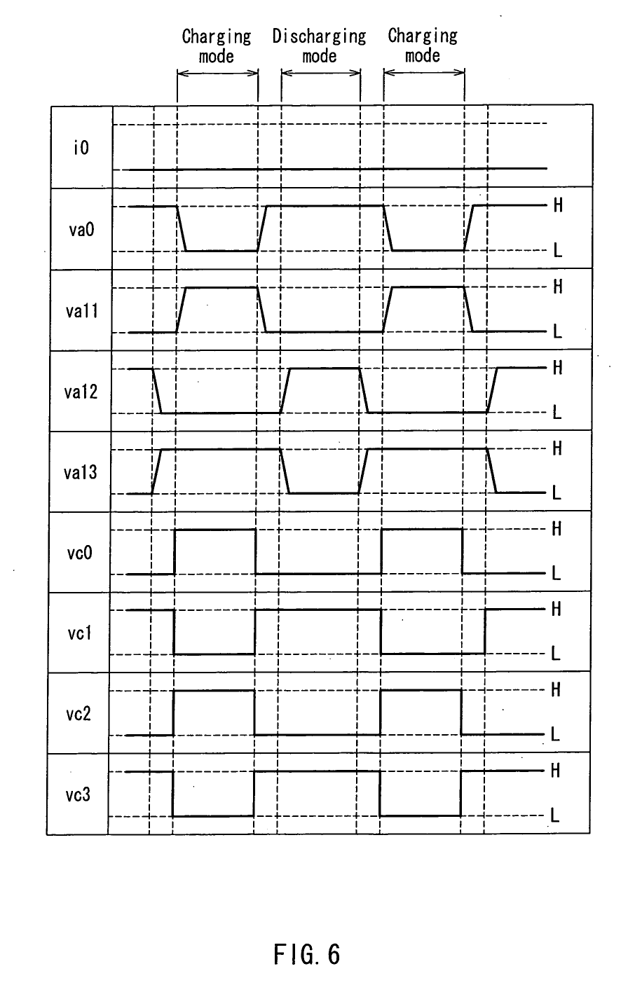

Further, though the voltage step-down charge pump circuit case is described as the present embodiment, the same configuration is applicable to a voltage step-up charge pump circuit. Thus, in the case of a voltage step-up charge pump circuit, it also is possible to obtain a charge pump circuit in which a spike noise has less impact on an analog signal processing circuit. A circuit diagram of a charge pump circuit having such a configuration is shown in FIG. 5, and timing clocks of the same are shown in FIG. 6.

FIG. 5 shows a voltage step-up charge pump circuit 16 having a configuration corresponding to the circuit shown in FIG. 3. In this circuit, the configurations involving the driving transistors 4 and 6 are identical to those of the circuit shown in FIG. 3. The configurations involving the driving transistors 17 and 18 are different from those of the driving transistors 5 and 7 in the circuit shown in FIG. 3.

The driving transistor 17 is connected between a positive terminal of the flying capacitor 2 and a positive terminal of the charge capacitor 3. A negative terminal of the charge capacitor 3 is connected to a ground voltage GND. The driving transistor 18 is connected between a negative terminal of the flying capacitor 2 and a power source voltage VDD. A PMOS transistor is used for forming the driving transistor 17, while a NMOS transistor is used for forming the driving transistor 18. To gates of the driving transistors 17 and 18, gate driving buffers 19 and 21 are connected, respectively. Gate control signals va13 and va12 are supplied thereto from a clock generator 9c via the gate driving buffers 19 and 21, respectively. The gates of the driving transistors 17 and 18 are provided with a gate voltage keeping switch 20 formed with a PMOS transistor and a gate voltage keeping switch 22 formed with a NMOS transistor, respectively. The gate voltage keeping switches 20 and 22 are controlled according to the gate control signals vc3 and vc2, respectively.

By repeating the charging and discharging with respect to the flying capacitor 2 and the transfer of charges therefrom to the charge capacitor 3, the voltage step-up at the charge capacitor 3 is carried out. The operation is shown by the timing clocks in FIG. 6, and it corresponds to the operation of the voltage step-down circuit according to the above-described embodiment.

### Embodiment 2

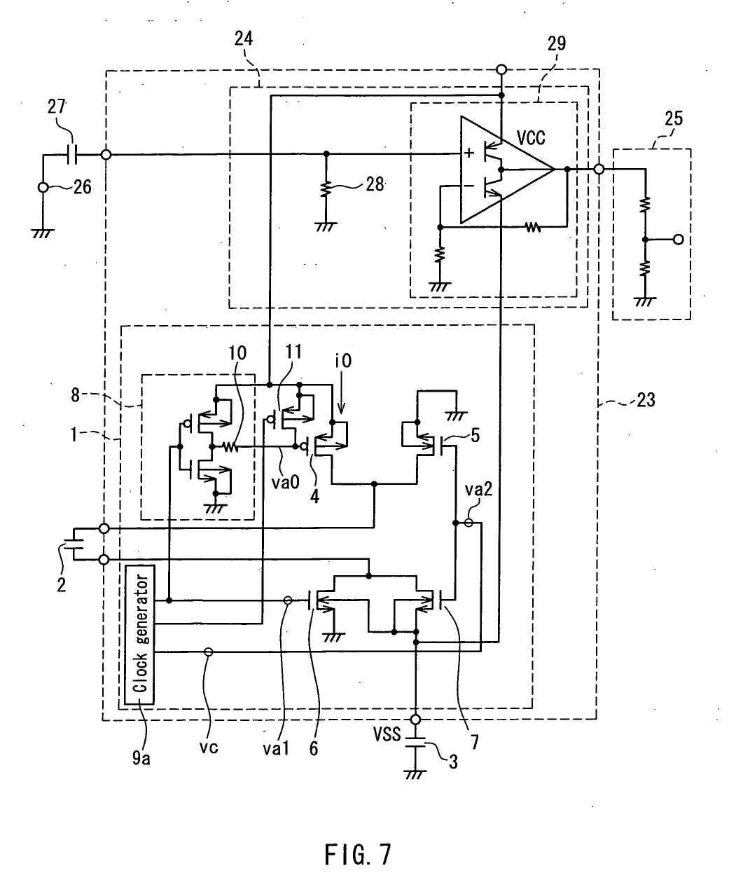

The following describes Embodiment 2 of the present invention while referring to FIG. 7. FIG. 7 illustrates a configuration of a semiconductor integrated circuit according to the present embodiment.

A semiconductor integrated circuit 23 of FIG. 7 includes a charge pump circuit 1 having the configuration shown in FIG. 1, and a signal processing circuit 24, thereby composing a signal processing circuit incorporating a charge pump circuit. The semiconductor integrated circuit 23 is connected with a flying capacitor 2, a charge capacitor 3, a terminal resistor 25, an input signal source 26, and an input capacitor 27.

In the present embodiment, the signal processing circuit 24 is composed of a resistor 28 and an output driver circuit 29, and as its power supply, a negative voltage supply VSS is used, which is connected with a power supply VCC and a negative terminal of the charge capacitor 3 of the charge pump circuit.

Since the semiconductor integrated circuit 23 incorporates the charge pump circuit 1, a dynamic range thereof can be expanded by approximately twice. Further, since the generation of spike noise is suppressed by the charge pump circuit 1 as described above, the charge pump circuit 1 and the signal processing circuit 24 can be driven by one power supply voltage, and the impact of the spike noise on the signal processing circuit 24 is suppressed.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A charge pump circuit comprising:
terminals connectable with a flying capacitor to be charged by a power supply voltage;
a terminal connectable with a charge capacitor to be charged with charges stored in the flying capacitor and transferred thereto; and
driving transistors connected with the terminals connectable with the flying capacitor and the charge capacitor, the power supply voltage, and a ground potential, for controlling the charging of the flying capacitor, and the transfer of charges from the flying capacitor to the charge capacitor,
the charge pump circuit being driven to repeat alternately an operation of charging the flying capacitor and an operation of transferring charges stored in the flying capacitor to the charge capacitor according to control signals supplied to gates of the driving transistors, so that the charge capacitor outputs a stepped-down or stepped-up power supply voltage,
wherein the charge pump circuit further comprises:
a driving buffer connected to a gate of at least one of the driving transistors via an impedance element so that the control signal is supplied thereto via the driving buffer, and
a switching element connected between the impedance element and the gate of the driving transistor so that when the driving transistor is turned off, the gate is switched to low impedance by the switching element.

2. The charge pump circuit according to claim 1,
wherein the switching element is composed of a switch that electrically connects the gate of the driving transistor connected with the driving buffer to the power supply voltage when the driving transistor is turned off.

3. The charge pump circuit according to claim 1,
wherein the driving transistors include:
driving transistors connected between a positive terminal of the flying capacitor and the power supply voltage and between a negative terminal of the flying capacitor and the ground potential, respectively, for controlling the charging of the flying capacitor; and
driving transistors connected between the positive terminal of the flying capacitor and the ground potential and between the negative terminal of the flying capacitor and the charge capacitor, respectively, for controlling the transfer of charges from the flying capacitor to the charge capacitor.

4. The charge pump circuit according to claim 1,
wherein the driving transistors include:
driving transistors connected between a positive terminal of the flying capacitor and the power supply voltage and between a negative terminal of the flying capacitor and the ground potential, respectively, for controlling the charging of the flying capacitor; and
driving transistors connected between the positive terminal of the flying capacitor and the charge capacitor and between the negative terminal of the flying capacitor and the power supply voltage, respectively, for controlling the transfer of charges from the flying capacitor to the charge capacitor.

5. A semiconductor integrated circuit comprising:
a charge pump circuit; and
a signal processing circuit that is provided on the same substrate that the charge pump circuit is provided on, that is connected with the charge pump circuit, and that can be driven with the same power supply voltage as that for driving the charge pump circuit,
wherein the charge pump circuit comprises:
terminals connectable with a flying capacitor to be charged by a power supply voltage;
a terminal connectable with a charge capacitor to be charged with charges stored in the flying capacitor and transferred thereto; and
driving transistors connected with the terminals connectable with the flying capacitor and the charge capacitor, the power supply voltage, and a ground potential, for controlling the charging of the flying capacitor, and the transfer of charges from the flying capacitor to the charge capacitor,
the charge pump circuit being driven to repeat alternately an operation of charging the flying capacitor and an operation of transferring charges stored in the flying capacitor to the charge capacitor according to control signals supplied to gates of the driving transistors, so that the charge capacitor outputs a stepped-down or stepped-up power supply voltage,
wherein the charge pump circuit further comprises:
a driving buffer connected to a gate of at least one of the driving transistors via an impedance element so that the control signal is supplied thereto via the driving buffer, and
a switching element connected between the impedance element and the gate of the driving transistor so that when the driving transistor is turned off, the gate is switched to low impedance by the switching element.

6. The semiconductor integrated circuit according to claim 5, wherein the switching element is composed of a switch that provides electric connection between the gate of the driving transistor connected with the driving buffer and the power supply voltage when the driving transistor is turned off.
